(19) United States
(12) Patent Application Publication
(10) Pub. No.: US 2007/0220265 A1
(43) Pub. Date: Sep. 20, 2007

(54) SEARCHING FOR A SCALING FACTOR FOR WATERMARK DETECTION

(75) Inventors: Aweke Negash Lemma, Eindhoven (NL); Leon Maria Van De Kerkhof, Eindhoven (NL); Minne Van Der Veen, Eindhoven (NL); Jaap Andre Haitsma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,440

(22) PCT Filed: Jun. 8, 2005
(86) PCT No.: PCT/IB05/51862

§ 371 Date: Dec. 12, 2006

(30) Foreign Application Priority Data
Jun. 16, 2004 (EP) 04102737.6

(51) Int. Cl. H04L 9/36

(52) U.S. Cl. 713/176; 380/54

(57) ABSTRACT

There is provided a watermark detector (20) including an input for receiving an input signal (Y′) including watermark content (W) to be searched. A first processor (40) of the detector (20) is operable to analyse portions (100, 110, 120) of the signal (Y′) to identify corresponding sets of characteristic properties or fingerprints (P₁ to P_{q}) and associated temporal descriptors (d₁ to d_{q}). A communication link to a database (50) is provided for communicating the fingerprints to the database (50) to identify the signal and to determine corresponding temporal descriptors (MT₁ to MT_{q}) corresponding to the portions (100, 110, 120) in the original signal. A second processor (220) is included for calculating from a difference between the temporal descriptors (d₁ to d_{q}) and the retrieved temporal descriptors (MT₁ to MT_{q}) a scaling factor to which the input signal (Y′) has been subjected. The scaling factor is useable for re-scaling the signal and extracting the watermark from the rescaled signal (Y′).

### FIELD OF THE INVENTION

The present invention relates to methods of searching for scaling factor, for example a method of searching for geometrical scaling factor in association with watermark detection. Moreover, the invention also relates to apparatus arranged to implement the methods. Furthermore, the invention concerns software executable on computing devices for implementing the methods, and also to databases operable to provide scaling factor estimates for use in these methods.

### BACKGROUND TO THE INVENTION

Unauthorised copying of data content, for example audio and video data content recorded on data carriers such as CD's and DVD's as well as distributed via communication networks such as the Internet, has been responsible for considerable financial loss to record and film industries during the past decade. To try to prevent such copying, watermark features are conventionally included in both audio data content and video data content. Forensic investigations are undertaken for determining commercial routes of unauthorised distribution of data content and thereby taking action, for example under copyright law, to prevent such unauthorised distribution; these investigations often involve detecting such watermark features. In particular, for forensic purposes, watermark features embedded into data content convey identification information referred to as a data payload of the watermark features.

In order not to degrade audio and video data content perceptibly, watermark features are embedded lightly into such data content. Lightly embedded watermark features are often difficult to detect, especially if audio or video data content into which watermark features have been lightly embedded has been subjected to processing steps causing loss of information in the watermarked audio or video data content.

Methods of embedding and retrieving watermarks are known. For example, such methods are described in a published international PCT patent application no. WO 03/096337. The patent application defines “fingerprinting” as being a technique to identify multimedia signals by extracting robust perceptual features of given signal contents and searching the extracted features in a database where titles, artists and similar information are stored. Moreover, the published application also defines watermarking as being a technique to embed payload data in a signal in an unobtrusive manner. In the patent application, there is described a method involving co-application of such watermarking and fingerprinting. In the method, an original fingerprint M(i) is extracted from a host signal X and then stored in a database. Next, a watermark W(i) is embedded in the host signal X to generate a corresponding modified signal X′ whose fingerprint M′(i) differs slightly from the fingerprint M(i) included in the original host signal X. When the modified signal X′ is received at a receiver, the fingerprint M′(i) is extracted from the received signal X′ and then used for checking against the database. The database responds by sending the original fingerprint M(i). The receiver then subtracts the original fingerprint M(i) of the modified fingerprint M′(i) to obtain the watermark W(i).

Watermark detection is often difficult to implement in practice, especially when watermarks are lightly embedded in order to preserve original high quality data content, for example as in HD video programme data content. Geometrical scaling of audio and video data content renders it difficult to extract faint watermark features because watermark detectors are obliged repetitively to process data content for a range of potential geometrical scaling factors before successfully determining the scaling factor for which watermark payload information is susceptible to being reliably extracted. Thus, contemporary watermark detectors often do not employ a sufficiently efficient method of watermark detection to cope with geometrically scaled data content, such scaling potentially rendering watermark features undetectable in audio and/or visual data content.

By way of definition, change in “geometrical scaling factor” in the case of audio recording relates to utilising a playback speed which is not identical to a corresponding recording speed and thereby shifting all frequencies by a similar relative ratio in the played content. Moreover, change in “geometrical scaling factor” in the case of video content relates to change in spatial scaling in one or more image directions, for example in a substantially horizontal direction and/or in a substantially vertical direction.

### SUMMARY OF THE INVENTION

An object of the present invention is to provide a method of searching for scaling factor in association with watermark detection.

According to a first aspect of the present invention, there is provided a method of searching for scaling factor in association with watermark detection, the method including steps of:
(a) receiving an input signal including potential watermark content to be searched;
(b) analysing portions of the signal to identify corresponding sets of characteristic properties and associated measured temporal descriptors thereof;
(c) matching the sets of characteristic properties with reference data to determine corresponding expected temporal descriptors corresponding to the portions; and
(d) calculating from a difference between the measured temporal descriptors and the expected temporal descriptors a scaling factor to which the input signal has been subjected.

The invention is of advantage in that the method is capable of providing enhanced watermark detection speed and a more robust measure of scaling factor changes.

“Matching” is to be construed to include one or more of correlation, comparison of terms, least squares error analysis, or any other approach to associate data.

Preferably, the method includes a further step of re-scaling the input signal using the scaling factor determined in step (d) to generate a corresponding re-scaled input signal and then extracting watermark information from the re-scaled input signal. Such re-scaling enables the input signal to be re-scaled before being presented to a watermark detector, thereby enhancing reliability and/or speed of watermark detection. Moreover, the use of standard watermark detection hardware is potentially possible, thereby rendering the method more straightforward to implement using known contemporary watermark detectors.

Preferably, for further refining reliability and accuracy of watermark detection, the method includes a further step of applying a scaling factor iterated around the scaling factor from step (d) for extracting the watermark information.

Preferably, in the method, the sets of characteristic properties correspond to content fingerprints of the input signal. Such fingerprints beneficially correspond to properties such as visual features, marker features, tagging features included in the input signal.

Preferably, to provide users with potentially useful additional supplementary information, the method includes a further step of using the sets of characteristic properties to identify meta-data pertaining to programme data content of the input signal.

Preferably, in the method, at least a portion of the reference data is generated in real-time in response to receiving one or more sets of characteristic properties. Such real-time generation of the reference data is of benefit in reduces the amount of information being necessary to store in memory.

Preferably, in step (b) of the method, at least one of the portions corresponds to at least one fragment of the signal having a playing duration in a range of 1 to 10 seconds, preferably substantially 3 seconds. Such a duration is beneficial in that it allows for potentially rapid determination of the measure of scaling factor and/or extraction of watermark content.

Preferably, the method includes a further step of arranging for the scaling factor calculated in step (d) to correct for at least one of following distortions applied to the input signal: temporal scaling factor distortion, spatial scaling factor distortion, spatial filtration distortion, temporal filtration distortion. Such distortions correspond to complex types of distortion often applied by counterfeiters to evade watermark detection; the ability of the method to cope with addressing such distortions is capable of rendering it more robust.

Preferably, in the method, the input signal is a multimedia signal including at least one of: audio, speech, images and video.

According to a second aspect of the invention, there is provided a watermark detector operable to search for scaling factor in association with watermark detection, the detector including:
(a) an input for receiving an input signal including potential watermark content to be searched;
(b) a first processor for analysing portions of the signal to identify corresponding sets of characteristic properties and associated measured temporal descriptors thereof;
(c) a communication link to a database for communicating said set of characteristic properties to the database for enabling matching of the sets of characteristic properties with reference data to determine corresponding expected temporal descriptors corresponding to the portions; and
(d) a second processor for calculating from a difference between the measured temporal descriptors and the expected temporal descriptors a scaling factor to which the input signal has been subjected.

According to a third aspect of the invention, there is provided a watermark detection system including a detector according to the second aspect of the invention couplable in communication with a database, said database being operable to provide expected temporal descriptors corresponding to sets of characteristic properties derivable at the detector from analysis of an input signal, said expected temporal descriptors being useable together with measured temporal descriptors associated with the sets of properties for calculating a scaling factor to which the input signal has been subjected, said scaling factor being useable for directing watermark detection within the detector.

According to a fourth aspect of the invention, there is provided a database couplable to a detector according to the second aspect of the invention, said database including data pertaining to expected scaling factor and associated expected sets of characteristic properties, said associated expected sets of characteristic properties being matchable to measured sets of characteristic properties derived from analysis of an input signal so as to relate said expected scaling factor to said measured sets of characteristic properties derived from analysis of the input signal.

It will be appreciated that features of the invention are susceptible to being combined in any combination without departing from the scope of the invention.

### DESCRIPTION OF THE DIAGRAMS

Embodiments of the invention will now be described, by way of example only, with reference to the following diagrams wherein:

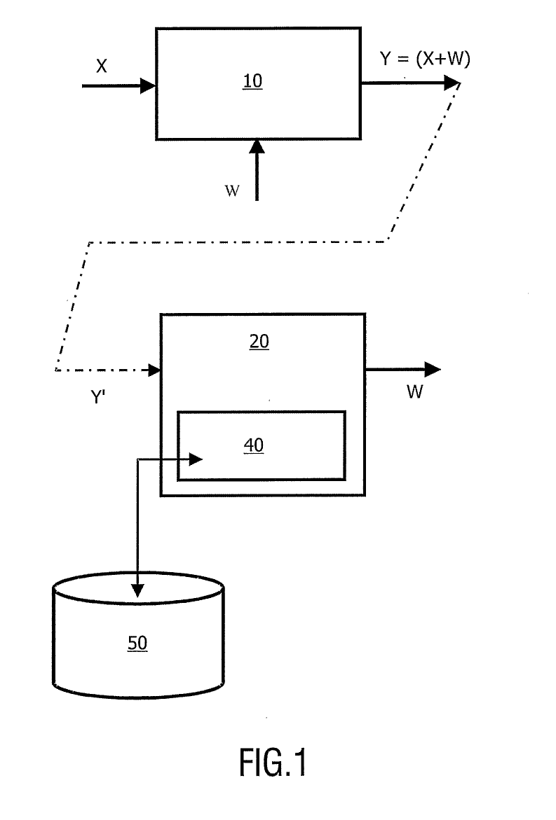

FIG. 1 is a schematic diagram of a watermark system capable of implementing a method of searching for geometrical scaling factor according to the invention;

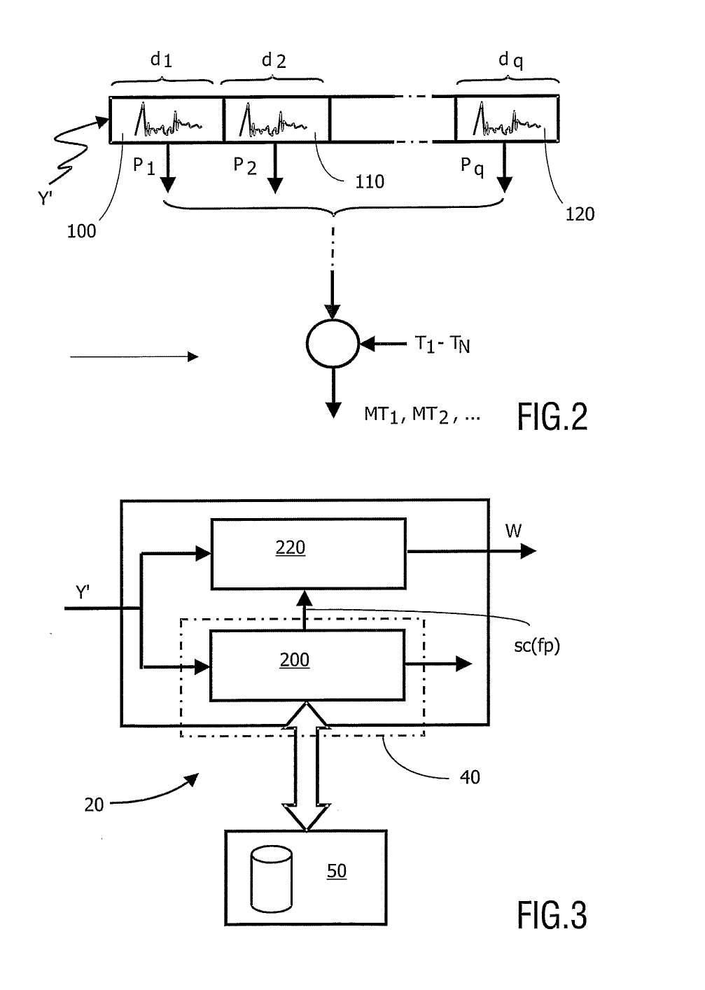

FIG. 2 is a schematic diagram of fingerprint extraction for implementing the method pertaining to FIG. 1;

FIG. 3 is a schematic diagram of a watermark detector according to the invention; and

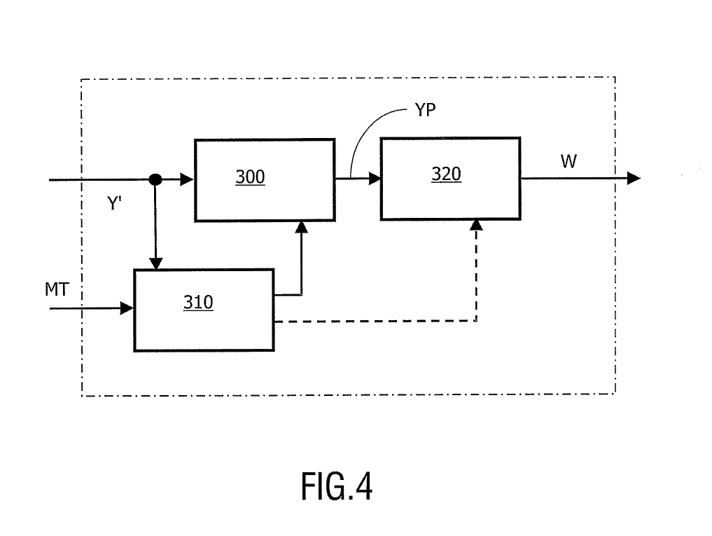

FIG. 4 is a flow chart illustrating processing functions performed within the detector of FIG. 3.

### DESCRIPTION OF EMBODIMENTS OF THE INVENTION

In FIG. 1, there is shown a watermark encoder 10. The encoder 10 is operable to receive an input signal X and watermark data W. Moreover, the encoder 10 is operable to output a corresponding watermarked signal Y according to Equation 1 (Eq. 1) wherein:
Y=X+W Eq. 1

A watermark detector 20 is operable to receive a signal Y′ to extract the watermark W therefrom. Generally, the detector 20 is capable of routinely extracting the watermark W from the signal Y′.

However, a difficulty potentially arises when the signal Y is subject to one or more processing steps to generate the signal Y′, for example one or more of quantization, compression, frequency scaling audio content by speed-up or slow-down, spatial scaling video content in one or more image spatial directions, resulting in the signal Y′ being distorted relative to the signal Y. Spatial scaling of video content includes, for example, processing the signal Y though spatial band-pass filters which distort watermark features present in the signal Y. Moreover, temporal scaling, also referred to as frequency scaling, effectively corresponds to a modification of sampling frequency used in generating the signal Y′. When the detector 20 is not designed to handle one or more of these types of distortion, the watermark data W is potentially not reliably detected or in worst case not found.

In order to improve the detector 20, one known approach is based on performing an exhaustive search for the watermark in the signal Y′ in scale ranges of interest Such an exhaustive search potentially reduces a probability of not detecting a watermark in watermarked data content. However, for a given detection threshold, such an exhaustive search also potentially gives rise to false positive watermark detection, for example erroneously detecting presence of a watermark in un-watermarked data content. Modifying a detection threshold for watermark detection potentially renders such an exhaustive search less robust.

The detection threshold is more preferably set in accordance with the number of scale-search tests performed on the signal Y′ to detect the watermark data W therein. Moreover, an efficient method of addressing temporal scaling utilises intermediate stored estimates of a presumed non-scaled watermark; such an approach is susceptible to being further improved by employing linear interpolation. This efficient method effectively involves re-sampling the signal Y′ at an expected time setting according to Equation 2 (Eq. 2):

$$N = \frac{{η}_{max} - {η}_{min}}{Δ} \qquad Eq . 2$$

wherein
Δ=a search grid size
ηₘₐₓ=maximum time scale
ηₘᵢₙ=minimum time scale

The searches for the watermark data require multiple correlations to be performed which is computationally demanding to identify a best geometrical scaling factor for use in detecting the watermark data W. The aforementioned distortions can arise on account of several factors, for example with regard to temporal scaling:
(a) variations in clocking speeds of analogue-to-digital (AD) and digital-to-analogue (DA) converters, such variations often in practice being in the order of 0.01%; and
(b) speed modification by broadcasters, for example it is common practice to increase the playback tempo of commercial recordings, for example pop songs, in a range from 0% to 4% in order to render the commercial recordings more aesthetically appealing or impressive.

In an embodiment of the present invention, the detector 20 is arranged to include a fingerprint extraction device 40; a “fingerprint” is defined to be robust perceptual features or properties that are susceptible to being used for searching in a database where parameters, timestamps/temporal descriptors, titles, artists and similar information are stored, for example in meta-data associated with data content. Preferably, the extraction device 40 is capable of robustly handling temporal scaling changes in a range of −5% to +5% that have been applied to the signal Y when generating the signal Y′. Thus, the device 40 is preferably coupled in communication with a database 50 so that data content fingerprints extracted by the device 40 can be associated with corresponding data stored in the database 50.

Operation of the detector 20 will now be described with reference to FIG. 2. The detector 20 receives the signal Y′. The device 40 extracts a series of q excerpts 100 to 120 of duration d₁ to d_{q} respectively where q is an integer greater than unity. Moreover, for the q excerpts 100 to 120, the device 40 determines corresponding sets of properties P₁ to P_{q} by way of fingerprint extraction, namely distinguishing principal distinguishing features, each set of properties can be regarded as corresponding to a fingerprint of its associated excerpt. The durations d₁ to d_{q} are preferably each in a range of 1 second to 10 seconds, and more preferably substantially 3 seconds.

The device 40 next communicates at least one the properties P₁ to P_{q} to the database 50, each of the properties representing a fingerprint as elucidated in the foregoing. The database 50 subsequently attempts to match the sets of properties P₁ to P_{q} received from the device 40 with N records of properties T₁ to T_{N} stored at the database 50 to determine a recording from which the excerpts 100 to 120 originate.

It will be appreciated that the sets of characteristic properties P₁ to P_{q} defining a series of fingerprints of the signal Y′ optionally useable to identify programme content meta-data stored in the database 50 corresponding to the signal Y′. Identification of such meta-data can have several potential applications, for example providing supplementary user information and searching the database 50 for related data content, for example other related films or audio recordings.

In accordance with the invention, the database now determines one or more time indications MT₁ to MT_{q} from the recording wherefrom the excerpts 100 to 120 originate; the time indications MT₁ to MT_{q} are also known as “time stamps”. The time indications MT₁ to MT_{q} are susceptible to being retrieved from the database 50 to an accuracy of substantially 20 milliseconds. By comparing the duration d₁ to d_{q} determined by the device 40 with time indications MT₁ to MT_{q} provided to the device 40 from the database 50, it is feasible to determine whether or not a speed change has occurred in the signal Y′ relative to the signal Y. For example, when two consecutive time indications MT₁ and MT₂ are obtained by the device 40 from the database, the device 40 compares (MT₂−MT₁) with the duration d₁ of the first excerpt. In a situation where the fingerprint of an excerpt of duration d₁=3 seconds is applied to the database, and the database reports (MT₂−MT₁)=3 seconds, no speed change has occurred, namely no scaling change has occurred. However, if the database reports that the time stamps MT₁ and MT₂ are 2.88 seconds apart, then a speed decrease of 4% must have been applied to the signal Y in generating the signal Y′. Therefore, an accurate estimation of temporal scaling factor can be calculated from time indications MT derived from fingerprint detection exercised by the device 40 in conjunction with the database 50.

As elucidated in the foregoing, contemporary watermark detectors tend to be less tolerant to speed variation and are susceptible to being unable to detect watermark information when a speed change of more than ±1% occurs between the signals Y and Y′. Even for speed variations of up to ±1%, contemporary watermark detectors need to perform a relatively large number of searches, for example typically several hundred searches, which is demanding with regard to computational resources. In the present invention, deriving expected scaling factor from the database 50 in response to fingerprint extraction executed by the device 40 enables subsequent watermark detection to be optionally iterated around the calculated scaling factor. Such an approach is capable of increasing watermark detection speed by an order of magnitude, for example by a factor of 10 to 20 times. As an example, the approach when applied to a conventional watermark detector has been found by experimental investigation to be capable of increasing speed of operation of the conventional detector by up to 20 times.

FIG. 3 provides a schematic illustration of the detector 20 operating in conjunction with the device 40 to implement the aforementioned approach. The detector 20 includes a fingerprint extractor 200 implemented in the device 40 coupled to a watermark detection device 220 for receiving geometrical scaling factor information sc(fp) from the extractor 200 corresponding to optimal fingerprint detection and using this information to direct searches for watermark content within a more appropriate range, thereby greatly enhancing rapidity and reliability of watermark detection.

In FIG. 4, functions performed within the detector 20 are denoted by 300, 310, 320. The function 310 is speed change estimation function for extracting the one or more sets of characteristic properties P₁ to P_{q} from the input signal Y′, for communicating these sets of properties P₁ to P_{q} to the database 50 for matching with stored properties T₁ to T_{N} and for subsequently receiving from the database 50 sets of expected timestamps denoted by MT for the signal Y′. Moreover, the function 300 is an inverse scaling operation which processes the signal Y′ to generate a corresponding re-scaled signal YP of the signal Y′. Furthermore, the function 320 is a watermark detection function which processes the re-scaled signal YP to detect watermark content embedded therein. The function 320 is operable to iterate around the estimated scaling factor MT to determine a condition where the watermark content W is most reliably detected in the re-scaled signal YP and thereby determine, in conjunction with the estimated scaling factor MT, the measure of scaling factor that the signal Y has been subjected to in generating the corresponding modified signal Y′.

Thus, in conclusion, the detector 20 is arranged to execute a method of detecting a watermark in the signal Y′, for example the signal Y′ being a multimedia signal. The method includes a first step of extracting fingerprint properties from the signal Y′ and matching these properties in the database 50 to obtain an estimated temporal scaling factor MT. Moreover, the method also includes a second step of using the estimated scaling factor MT by way of performing an iterative search around this estimated scaling factor in the signal Y′ to extract the watermark content W embedded in the signal Y′. Data stored in the database 50 for matching with the sets of characteristic properties P₁ to P_{q} extracted from the signal Y′ is preferably itself in the form of fingerprint data. Furthermore, the signals Y, Y′ are preferably multimedia signals, for example at least one of audio, speech, images and video.

Apart from addressing issues of temporal scaling factor distortions between the signals Y, Y′, the detector 20 is capable of alternatively or additionally addressing spatial scaling factor changes and other forms of geometrical distortions in a similar manner using the aforementioned approach, namely using fingerprint detection to obtain an estimation of scaling factor from the database 50 followed by more precisely directed iterative watermark detection executed within the detector 20.

In the accompanying claims, numerals and other symbols included within brackets are included to assist understanding of the claims and are not intended to limit the scope of the claims in any way.

It will be appreciated that embodiments of the invention described in the foregoing are susceptible to being modified without departing from the scope of the invention as defined by the accompanying claims.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed to be a reference to the plural and vice versa.

The invention can be summarized as follows. There is provided a watermark detector (20) including an input for receiving an input signal (Y′) including watermark content (W) to be searched. A first processor (40) of the detector (20) is operable to analyse portions (100, 110, 120) of the signal (Y′) to identify corresponding sets of characteristic properties or fingerprints (P₁ to P_{q}) and associated temporal descriptors (d₁ to d_{q}). A communication link to a database (50) is provided for communicating the fingerprints to the database (50) to identify the signal and to determine corresponding temporal descriptors (MT₁ to MT_{q}) corresponding to the portions (100, 110, 120) in the original signal. A second processor (220) is included for calculating from a difference between the temporal descriptors (d₁ to d_{q}) and the retrieved temporal descriptors (MT₁ to MT_{q}) a scaling factor to which the input signal (Y′) has been subjected. The scaling factor is useable for re-scaling the signal and extracting the watermark from the rescaled signal (Y′).

1. A method of searching for scaling factor in association with watermark detection, the method including steps of:
(a) receiving an input signal (Y′) including potential watermark content (W) to be searched;
(b) analysing portions (100, 110, 120) of the signal (Y′) to identify corresponding sets of characteristic properties (P₁ to P_{q}) and associated measured temporal descriptors (d₁to d_{q}) thereof;
(c) matching the sets of characteristic properties (P₁ to P_{q}) with reference data (T₁ to T_{N}) to determine corresponding expected temporal descriptors (MT₁ to MT_{q}) corresponding to the portions (100, 110, 120); and
(d) calculating from a difference between the measured temporal descriptors (d₁ to d_{q}) and the expected temporal descriptors (MT₁ to MT_{q}) a scaling factor to which the input signal (Y′) has been subjected.

2. A method according to claim 1, including a further step of re-scaling the input signal (Y′) using the scaling factor determined in step (d) to generate a corresponding re-scaled input signal and then extracting watermark information from the re-scaled input signal (Y′).

3. A method according to claim 2, including a further step of applying a scaling factor iterated around the scaling factor from step (d) for extracting the watermark information.

4. A method according to claim 1, wherein the sets of characteristic properties (P₁ to P_{q}) correspond to content fingerprints of the input signal (Y′).

5. A method according to claim 1, including a further step of using the sets of characteristic properties (P₁ to P_{q}) to identify meta-data pertaining to programme data content of the input signal (Y′).

6. A method according to claim 1, wherein at least a portion of the reference data (T₁ to T_{N}) is generated in real-time in response to receiving one or more sets of characteristic properties (P₁ to P_{q}).

7. A method according to claim 1, wherein in step (b) at least one of the portions corresponds to at least one fragment of the signal (Y′) having a playing duration in a range of 1 to 10 seconds, preferably substantially 3 seconds.

8. A method according to claim 1, including a further step of arranging for the scaling factor calculated in step (d) to correct for at least one of following distortions applied to the input signal (Y′): temporal scaling factor distortion, spatial scaling factor distortion, spatial filtration distortion, temporal filtration distortion.

9. A method according to claim 1, wherein the input signal (Y′) is a multimedia signal including at least one of: audio, speech, images and video.

10. A watermark detector (20) operable to search for scaling factor in association with watermark detection, the detector including:
(a) an input for receiving an input signal (Y′) including potential watermark content (W) to be searched;
(b) a first processor (40) for analysing portions (100, 110, 120) of the signal (Y′) to identify corresponding sets of characteristic properties (P₁ to P_{q}) and associated measured temporal descriptors (d₁ to d_{q}) thereof;
(c) a communication link to a database (50) for communicating said set of characteristic properties (P₁ to P_{q}) to the database (50) for enabling matching of the sets of characteristic properties (P₁ to P_{q}) with reference data (T₁ to T_{N}) to determine corresponding expected temporal descriptors (MT₁ to MT_{q}) corresponding to the portions (100, 110, 120); and
(d) a second processor (220) for calculating from a difference between the measured temporal descriptors (d₁ to d_{q}) and the expected temporal descriptors (MT₁ to MT_{q}) a scaling factor to which the input signal (Y′) has been subjected.

11. A detector (20) according to claim 10, operable to apply the scaling factor determined by the second processor (220) to extract watermark content from the input signal (Y′).

12. A watermark detection system (20, 50) including a detector (20) according to claim 10 couplable in communication with a database (50), said database (50) being operable to provide expected temporal descriptors (MT₁ to MT_{q}) corresponding to sets of characteristic properties (P₁ to P_{q}) derivable at the detector (20) from analysis of an input signal (Y′), said expected temporal descriptors (MT₁ to MT_{q}) being useable together with measured temporal descriptors (d₁ to d_{q}) associated with the sets of properties (P₁ to P_{q}) for calculating a scaling factor to which the input signal (Y′) has been subjected, said scaling factor being useable for directing watermark detection within the detector (20).

13. A database (50) couplable to a detector (20) according to claim 10, said database (50) including data pertaining to expected scaling factor and associated expected sets of characteristic properties (T₁ to T_{N}), said associated expected sets of characteristic properties (T₁ to T_{N}) being matchable to measured sets of characteristic properties (P₁ to P_{q}) derived from analysis of an input signal (Y′) so as to relate said expected scaling factor to said measured sets of characteristic properties (P₁ to P_{q}) derived from analysis of the input signal (Y′).
